(19) United States
(12) Patent Application Publication
(10) Pub. No.: US 2009/0256811 A1
(43) Pub. Date: Oct. 15, 2009

(54) OPTICAL TOUCH SCREEN

(75) Inventor: Donato PASQUARIELLO, Vasteras (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/103,233

(22) Filed: Apr. 15, 2008

(51) Int. Cl. G06F 3/041

(52) U.S. Cl. 345/173

(57) ABSTRACT

A device may include a position sensitive detector that is configured to generate a value corresponding to a location associated with a shadow or absence of light on an upper surface of the position sensitive detector. The device may also include logic configured to receive the value, determine that a contact occurred on the display based on the value and determine a location of the contact based on the value.

### TECHNICAL FIELD OF THE INVENTION

The invention relates generally to displays and, more particularly, to optical touch screen displays.

### DESCRIPTION OF RELATED ART

Currently, most touch screens used in various devices for user input are resistive touch screens. Resistive touch screens may be applied to many types of displays and are relatively inexpensive. A drawback with resistive touch screens is that the resistive touch screen is applied to the front of the display. This reduces the front-of-screen (FOS) performance since the resistive touch screen components/layers are placed in front of the display.

Infrared (IR) touch screens are becoming increasingly common and have improved FOS performance as compared to resistive touch screens. In addition, IR touch screens do not suffer from sensor drift and therefore, do not require calibration. In IR touch screens, a touch is detected using electro-optical means, as opposed to mechanical means. Therefore, IR touch screens are not as sensitive to damage as other touch screens, such as resistive touch screens.

A drawback with IR touch screens, however, is cost. Existing IR touch screens use an array of IR light emitting diodes (LEDs) and an array of detectors. The cost for the array of LEDs and detectors, as well as the interconnection wiring, results in a very costly touch screen.

### SUMMARY

According to one aspect, a device is provided. The device includes a display comprising a first position sensitive detector, the first position detector configured to generate a first value corresponding to a location associated with a shadow or absence of light on an upper surface of the first position sensitive detector, and a second position sensitive detector, the second position sensitive detector configured to generate a second value corresponding to a location associated with a shadow or absence of light on an upper surface of the second position sensitive detector. The device also includes logic configured to receive the first and second values, determine that a contact occurred on the display, and determine a location of the contact based on the first and second values.

Additionally, the device may further comprise a first light source configured to illuminate all of the upper surface of the first position sensitive detector when no object is contacting the display, and a second light source configured to illuminate all of the upper surface of the second position sensitive detector when no object is contacting the display.

Additionally, the first position sensitive detector may be configured to generate the first value in response to a user's finger or stylus contacting the display, and the second position sensitive detector is configured to generate the second value in response to the user's finger or stylus contacting the display.

Additionally, the first and second light sources may each comprise at least one light emitting diode.

Additionally, the device may further comprise a first light guide located adjacent the first light source and on an opposite side of the display than the first position sensitive detector, the first light guide configured to direct light from the first light source to the first position sensitive director; and a second light guide located adjacent the second light source and on an opposite side of the display than the second position sensitive detector, the second light guide configured to direct light from the second light source to the second position sensitive detector.

Additionally, the logic may be further configured to determine an input element on the display corresponding to the location of the contact, and process the input element.

Additionally, when determining the location of the contact, the logic may be configured to determine coordinates associated with the contact, the coordinates being based on the first and second values and a length and width of the display.

Additionally, the device may further comprise a third position sensitive detector; and a fourth position sensitive detector, wherein two of the first, second, third and fourth position sensitive detectors are configured to output location information in response to a user's finger or stylus contacting an upper surface of the display.

Additionally, the logic may be further configured to determine which two of the four position sensitive detectors output location information, perform a first calculation to identify a location on the display when the first and second position sensitive detectors output location information, and perform a second calculation to identify a location on the display when the third and fourth position sensitive detectors output location information.

Additionally, the logic may be further configured to detect multiple contacts on the display that occur simultaneously or substantially simultaneously based on information received from the first, second, third and fourth position sensitive detectors.

Additionally, the device may comprise a mobile telephone.

According to another aspect, in a device comprising a display, a method is provided. The method includes generating, by a first position sensitive detector, a first value corresponding to a location associated with a shadow or absence of light on an upper surface of the first position sensitive detector. The method also includes determining that a contact occurred on the display based on the first value and determining a location of the contact based on the first value.

Additionally, the method may further comprise identifying a display element associated with the location of the contact and processing an input associated with the display element.

Additionally, the method may further comprise generating, by a second position sensitive detector, a second value corresponding to a location associated with a shadow or absence of light on an upper surface of the second position sensitive detector, wherein determining the location of the contact further comprises determining the location of the contact based on the second value.

Additionally, the generating a first value may comprise generating a current or voltage by the first position sensitive detector, and converting the current or voltage into a linear position on the first position sensitive detector, the linear position corresponding to the location associated with the shadow or absence of light on the upper surface of the first position sensitive detector. The generating a second value may comprise generating a current or voltage by the second position sensitive detector, and converting the current or voltage into a linear position on the second position sensitive detector, the linear position corresponding to the location associated with the shadow or absence of light on the upper surface of the second position sensitive detector.

Additionally, the method may further comprise monitoring output of the first and second position sensitive detectors and determining that the contact occurred when the current or voltage generated by at least one of the first and second position sensitive detectors is not zero.

Additionally, the device may comprise the first position sensitive detector, the second position sensitive detector, a third position sensitive detector and a fourth position sensitive detector. The method may further comprise generating location information, by two of the first, second, third and fourth position sensitive detectors, in response to a user's finger or stylus contacting an upper surface of the display.

Additionally, the method may further comprise detecting multiple contacts on the display that occur simultaneously or substantially simultaneously based on information received from the first and second position sensitive detectors.

According to still another aspect, a device comprises display means for generating first and second values corresponding to a location associated with a shadow or absence of light on a portion of the display means and input detection means for determining that a touch occurred on the touch screen based on the first and second values and determining a location of the touch based on the first and second values.

Additionally, the display means may comprise a plurality of position sensitive detectors, and wherein the input detection means is configured to receive location information from two of the position sensitive detectors in response to a user's finger or stylus contacting an upper surface of the touch screen.

Additionally, the device may further comprise input processing means for identifying a display element on the touch screen associated with the location of the touch and processing an input associated with the display element.

### BRIEF DESCRIPTION OF THE DRAWINGS

Reference is made to the attached drawings, wherein elements having the same reference number designation may represent like elements throughout.

FIG. 1 is a diagram of an exemplary mobile terminal in which methods and systems described herein may be implemented;

FIG. 2 is a diagram illustrating components of the mobile terminal of FIG. 1 according to an exemplary implementation;

FIG. 3 illustrates exemplary components of the mobile terminal of FIG. 1 according to an exemplary implementation;

FIG. 4A is a diagram schematically illustrating an exemplary PSD;

FIG. 4B is a diagram illustrating the relationship of the output of the PSD of FIG. 4A to the position of incident light;

FIG. 5A illustrates an exemplary PSD used in accordance with an exemplary implementation;

FIG. 5B illustrates the PDS of FIG. 5A used in a conventional mode;

FIG. 6 is a diagram schematically illustrating a one-dimensional optical touch screen according to an exemplary implementation;

FIG. 7 is a diagram schematically illustrating a two-dimensional optical touch screen according to an exemplary implementation;

FIG. 8 is a flow diagram illustrating exemplary processing according to an exemplary implementation;

FIGS. 9A and 9B are diagrams schematically illustrating touches on a display according to an exemplary implementation; and

FIG. 10 is a diagram schematically illustrating a two-dimensional optical touch screen according to another exemplary implementation.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Exemplary implementations of the invention will be described in the context of a mobile communication device. It should be understood that a mobile communication device is an example of a device that can employ a display consistent with the principles described herein and should not be construed as limiting the types or sizes of devices or applications that include displays described herein. For example, displays consistent with the principles described herein may be used on a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, an industrial device (e.g., test equipment, control equipment) or any other device that includes a display.

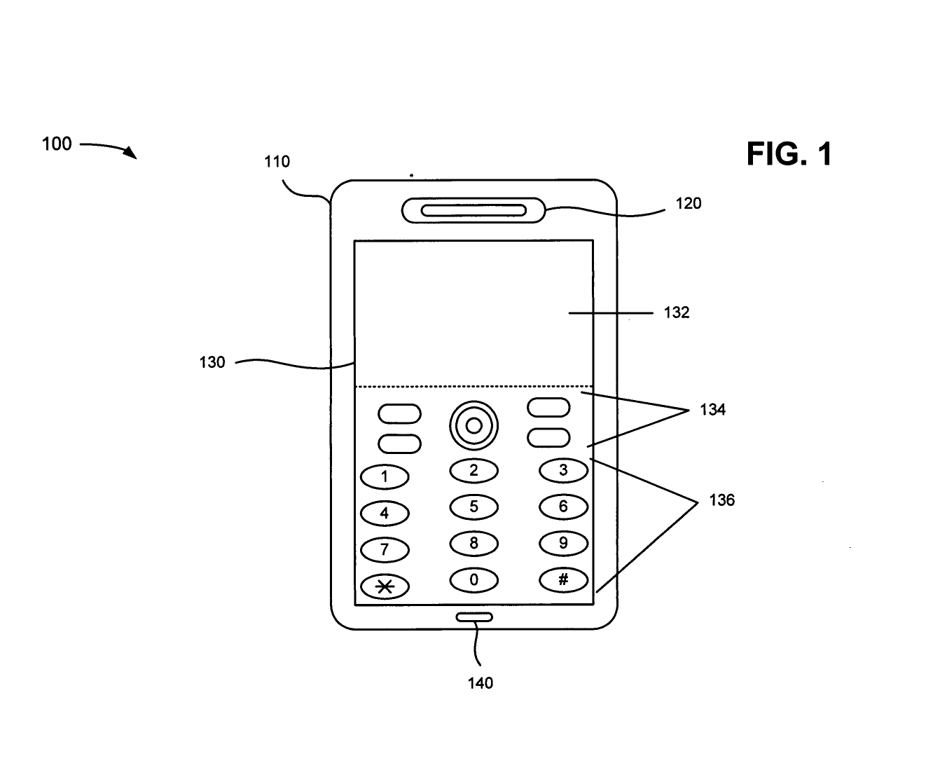

FIG. 1 is a diagram of an exemplary mobile terminal 100 in which methods and systems described herein may be implemented. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. Mobile terminal 100 may also include media playing capability. As described above, it should also be understood that systems and methods described herein may also be implemented in other devices that include displays, with or without including various other communication functionality.

Referring to FIG. 1, mobile terminal 100 may include a housing 110, a speaker 120, a display 130 and a microphone 140. Housing 110 may protect the components of mobile terminal 100 from outside elements. Speaker 120 may provide audible information to a user of mobile terminal 100. Microphone 140 may receive audible information from the user.

Display 130 may be a color display, such as a red, green, blue (RGB) display, a monochrome display or another type of display. In an exemplary implementation, display 130 may include an upper display area 132 (referred to herein as upper display 132) that provides visual information to the user. For example, upper display 132 may include the area located above the dotted line shown in FIG. 1 and may provide information regarding incoming or outgoing telephone calls and/or incoming or outgoing electronic mail (e-mail), instant messages, short message service (SMS) messages, etc. Upper display 132 may also display information regarding various applications, such as a phone book/contact list stored in mobile terminal 100, a telephone number, the current time, video games being played by a user, downloaded content (e.g., news or other information), etc.

Control buttons 134 may permit the user to interact with mobile terminal 100 to cause mobile terminal 100 to perform one or more operations, such as place a telephone call, play various media, etc. For example, control buttons 134 may include a dial button, hang up button, play button, etc. Keypad 136 may include a telephone keypad used to input information in mobile terminal 100.

In an exemplary implementation, display 130 may include a number of light sources that emit light in all directions, such as a light emitting diode (e.g., an organic LED (OLED), a polymer LED (poly-LED) or another type of LED). In another implementation, display 130 may include one or more light sources, such as an incandescent, fluorescent or other light source. Display 130 may also include a number of position sensitive detectors (PSDs). PSDs, in general, are monolithic detectors that provide continuous position data with respect to detected light. In an exemplary implementation, one or more PSDs may be used in an “inverse” mode to detect shadows or the absence of light on the surface of the PSD, as described in detail below.

In an exemplary implementation, control buttons 134 and keypad 136 may be part of display 130. That is, upper display 132, control buttons 134 and keypad 136 may be part of an optical touch screen display. In addition, in some implementations, different control buttons and keypad elements may be provided based on the particular mode in which mobile terminal 100 is operating. For example, when operating in a cell phone mode, a conventional telephone keypad may be displayed in area 136 and control buttons associated with dialing, hanging up, etc., may be displayed in area 134. When operating as a music playing device, keypad elements and control buttons associated with playing music may be displayed in areas 134 and 136. In each situation, a user may select a particular input by touching a particular part of display 130 and mobile terminal 100 may detect the particular input, as described in more detail below.

In other implementations, control buttons 134 and/or keypad 136 may not be part of display 130 (i.e., may not be part of an optical touch screen) and may include conventional input devices used to input information to mobile terminal 100. In such implementations, upper display 132 may operate as a touch screen display. In some implementations, control buttons 134 may include one or more buttons that controls various settings associated with display 130. For example, one of control buttons 134 may be used to toggle between operating upper display 132 as a conventional display (e.g., without touch screen capability) and operating upper display 132 as a touch screen display. Further, one of control buttons 134 may be a menu button that permits the user to view various settings associated with mobile terminal 100. Using the menu, a user may also be able to toggle upper display 132 between a conventional display and a touch screen display.

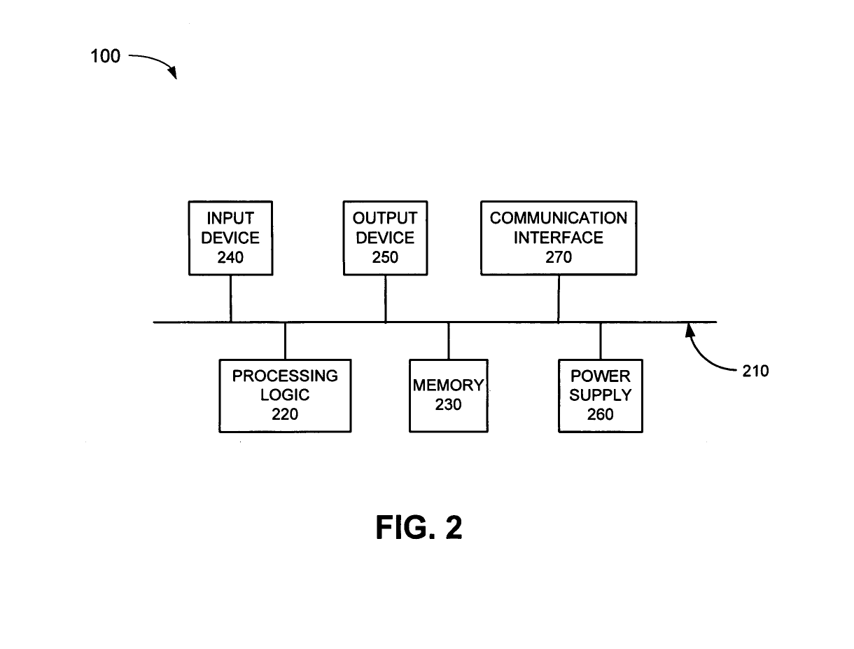

FIG. 2 is a diagram illustrating components of mobile terminal 100 according to an exemplary implementation. Mobile terminal 100 may include bus 210, processing logic 220, memory 230, input device 240, output device 250, power supply 260 and communication interface 270. Bus 210 permits communication among the components of mobile terminal 100. One skilled in the art would recognize that mobile terminal 100 may be configured in a number of other ways and may include other or different elements. For example, mobile terminal 100 may include one or more modulators, demodulators, encoders, decoders, etc., for processing data.

Processing logic 220 may include a processor, microprocessor, an application specific integrated circuit (ASIC), field programmable gate array (FPGA) or the like. Processing logic 220 may execute software instructions/programs or data structures to control operation of mobile terminal 100. In an exemplary implementation, processing logic 220 may include logic to control display 130. For example, processing logic 220 may determine whether a user has provided input to a touch screen portion of display 130, as described in detail below.

Memory 230 may include a random access memory (RAM) or another type of dynamic storage device that stores information and instructions for execution by processing logic 220; a read only memory (ROM) or another type of static storage device that stores static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more memory devices and/or carrier waves.

Input device 240 may include mechanisms that permit an operator to input information to mobile terminal 100, such as display 130, microphone 140, a keyboard, a mouse, a pen, voice recognition and/or biometric mechanisms, etc. For example, as discussed above, all or a portion of display 130 may function as a touch screen input device for inputting information to mobile terminal 100.

Output device 250 may include one or more mechanisms that output information from mobile terminal 100, including a display, such as display 130, a printer, one or more speakers, such as speaker 120, etc. Power supply 260 may include one or more batteries or other power source components used to supply power to components of mobile terminal 100. Power supply 260 may also include control logic to control application of power from power supply 260 to one or more components of mobile terminal 100.

Communication interface 270 may include any transceiver-like mechanism that enables mobile terminal 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers. Communication interface 270 may also include one or more antennas for transmitting and receiving RF data.

Mobile terminal 100 may provide a platform for a user to make and receive telephone calls, send and receive electronic mail, text messages, play various media, such as music files, video files, multi-media files, games, and execute various other applications. Mobile terminal 100 may also perform processing associated with display 130 operating as a touch screen input device. Mobile terminal 100 may perform operations in response to processing logic 220 executing sequences of instructions contained in a computer-readable storage medium, such as memory 230. Such instructions may be read into memory 230 from another computer-readable medium via, for example, communication interface 270. A computer-readable medium may include one or more memory devices and/or carrier waves. In alternative embodiments, hard-wired circuitry may be used in place of or in combination with software instructions to implement processes consistent with the invention. Thus, implementations described herein are not limited to any specific combination of hardware circuitry and software.

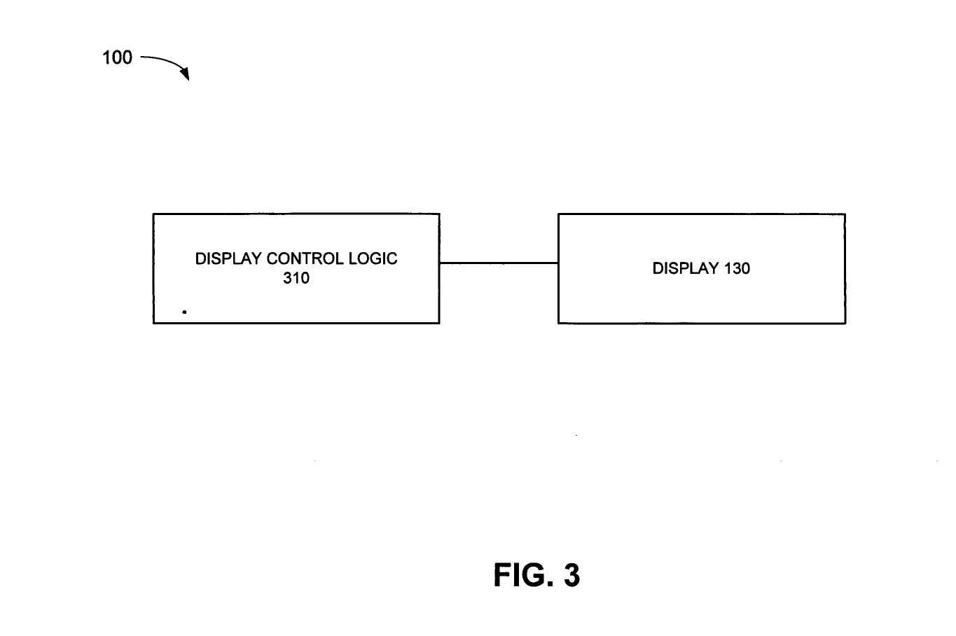

FIG. 3 is a functional diagram of components implemented in mobile terminal 100. Referring to FIG. 3, mobile terminal 100 may include display control logic 310 and display 130. Display control logic 310 may be included in processing logic 220. Alternatively, display control logic 310 may be external to processing logic 220, such as part of display 130.

Display control logic 310 may receive output from PSDs that are included in display 130. Display control logic 310 may use the output from the PSDs to identify coordinates or a location on display 130 that the user intended to touch to provide input to mobile terminal 100.

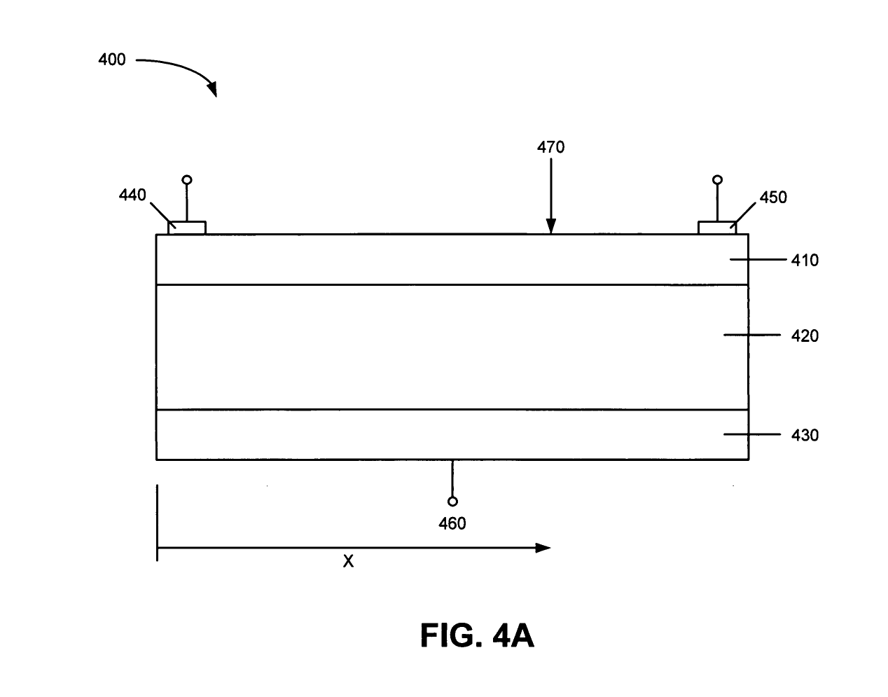

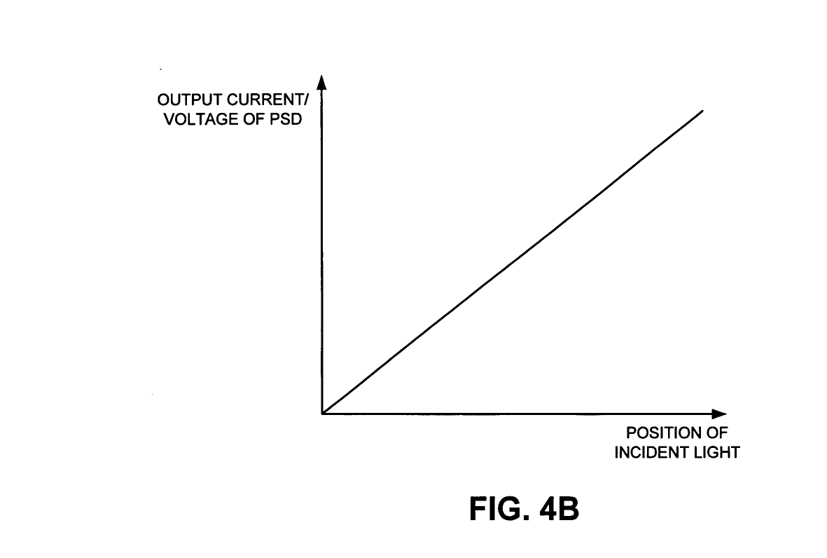

As described above, in an exemplary implementation, display 130 may include a number of position sensitive detectors (PSDs). In general, a PSD is an opto-electronic device which converts incident light into continuous position data. For example, a PSD may be operated as a photovoltaic or photodiode, where the output voltage or current is linearly dependent on the position of the incident light. FIG. 4A schematically illustrates the layout of an exemplary PSD that may be used to detect light and may also be used to detect touch on display 130, as described in more detail below. Referring to FIG. 4A, PSD 400 may include three layers 410, 420 and 430. Layer 410 may be a silicon layer doped with, for example, p-type impurities, such as boron. Layer 420 may be an intrinsic or undoped silicon layer. Layer 430 may be a silicon layer doped with, for example, n-type impurities, such as phosphorous or arsenic. PSD 400 may also include electrodes 440, 450 and 460.

The position of light that falls incident on layer 410 may be determined by PSD 400. For example, referring to FIG. 4A, assume that light represented by arrow 470 falls incident upon layer 410. PSD 400, as known in the art, may detect the position of light in one dimension (e.g., in the x-direction from one end of PSD 400, such as the distance X illustrated in FIG. 4A) based on the output current or voltage (or other electrical properties) measured at electrodes 440 and 450. For example, the position X may be determined based on the difference in the current (or voltage) measured at electrode 450 with the current (or voltage) measured at electrode 440 divided by the sum of the currents (or voltages) measured at electrodes 440 and 450. The resulting value may be multiplied by a scaling factor associated with, for example, the length of PSD 400. In FIG. 4A, as the value of X increases, the output current (or voltage) measured at electrode 450 increases since the total resistance associated with layer 410 will decrease based on the reduced distance from the location of the incident light on layer 410 to electrode 450. Conversely, the output current (or voltage) measured at electrode 440 decreases since the total resistance associated with layer 410 will increase based on the increased distance from the location of the incident light to electrode 440. As a result, the output of PSD 400 will increase since the difference in current (or voltage) measured at electrode 450 with respect to electrode 440 increases.

FIG. 4B schematically illustrates the dependence of the output current (or voltage) of PSD 400 based on the position of the incident light. As shown in FIG. 4B, the output current (or voltage) of PSD 400 increases as the distance X increases. That is, the closer the incident light falls on PSD 400 with respect to electrode 450, the greater the output current (or voltage) of PSD 400.

In an exemplary implementation, silicon layers 410, 420 and 430 of PSD 400 may be amorphous silicon layers. In other implementations, silicon layers 410, 420 and 430 may be crystalline silicon layers. Using crystalline silicon may result in increased signal strength associated with the current or voltage measured at electrodes 440 and 450, as compared to using amorphous silicon.

As discussed above, a conventional PSD, such as PSD 400 described above, may be used to detect light incident upon its surface. In an exemplary implementation, one or more PSDs may be used in an “inverse” mode of operation to detect the location of shadows or objects that inhibit or obstruct light from falling incident on the surface of the PSD. These shadows may be caused by a user's finger or stylus contacting the surface of a touch screen display, such as display 130.

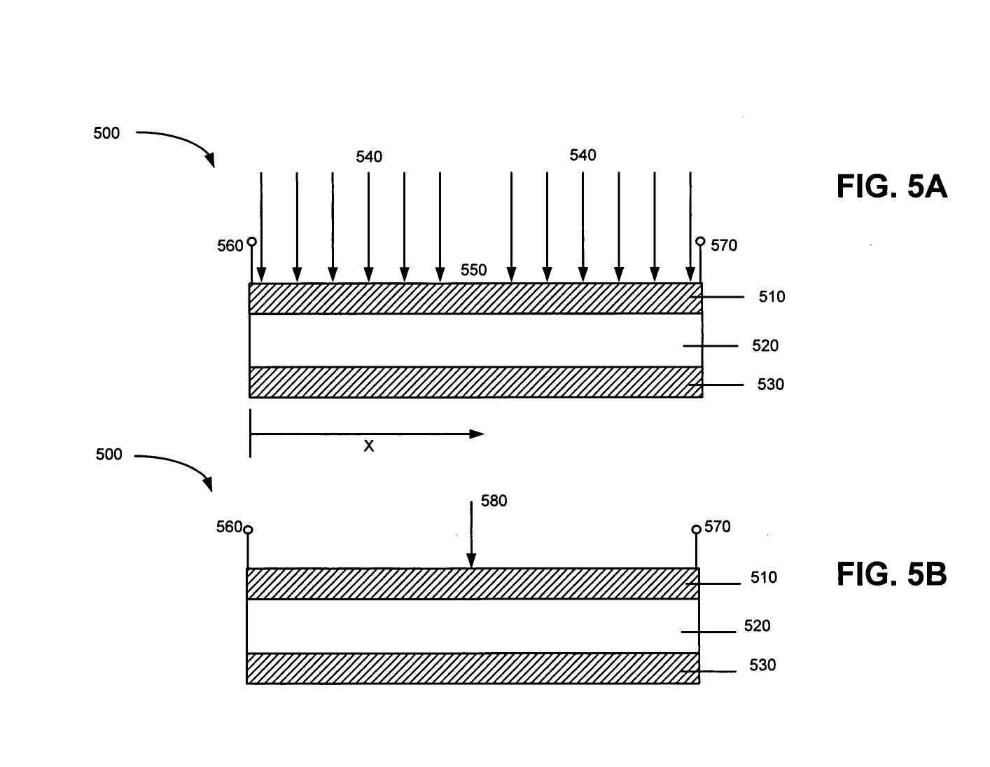

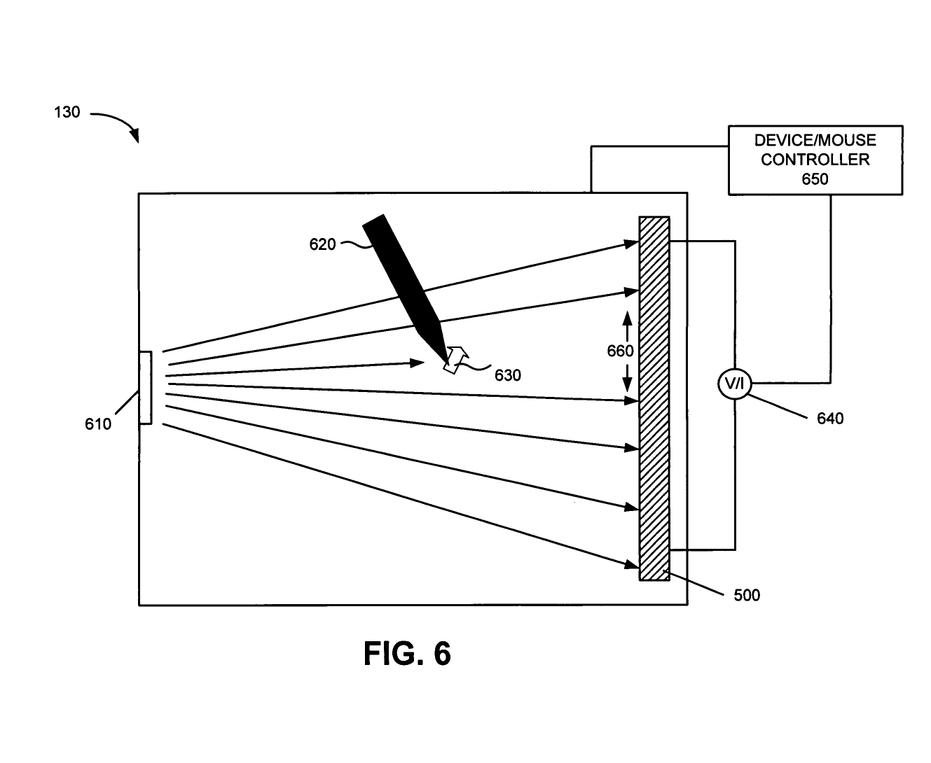

FIG. 5A illustrates an exemplary PSD used in accordance with an exemplary implementation of the invention. Referring to FIG. 5A, PSD 500 includes layers 510, 520 and 530. These layers may be similar in composition to layers 410, 420 and 430 described above with respect to FIG. 4A. PSD 500 may also include electrodes 560 and 570 used to measure current or voltage. Other electrodes (not shown), such as a common electrode coupled to layer 530 may also be included in PSD 500.

In an exemplary implementation, PSD 500 may be used to detect the location of shadows or lack of light on a portion of the upper surface of PSD 500. Such a location may be caused by a user's finger or stylus that that inhibit light from falling incident upon the surface of the PSD, as described in detail below. When light falls incident upon the entire surface of layer 510, PSD 500 may output zero current (or voltage). That is, the current or voltage measured at electrode 570 will be equal to the current (or voltage) measured at electrode 560. Therefore, the resulting difference between these currents (or voltages) will be zero and the output of PSD 500 will be zero.

In FIG. 5A, assume that light represented by arrows 540 falls on the surface of layer 510. At location 550, however, no light is incident upon layer 510. While operating in an “inverse” mode, PSD 500 may detect location 550 with respect to one end of PSD 500, such as the distance in the x direction from one of the sides of PSD 500 (labeled x in FIG. 5A). In this manner, a shadow or blockage of light caused by a finger or stylus on the surface of display 130 may be detected.

The inverse mode of PSD 500 described with respect to FIG. 5A is not the conventional mode used by PSDs. For example, as described above, conventional PSDs are used to detect the position of light incident upon the surface of the PSD. As an example, FIG. 5B illustrates the use of PSD 500 in a conventional mode. In this mode, PSD 500 may be used to detect the location of light, represented by arrow 580, on the surface of PSD 500.

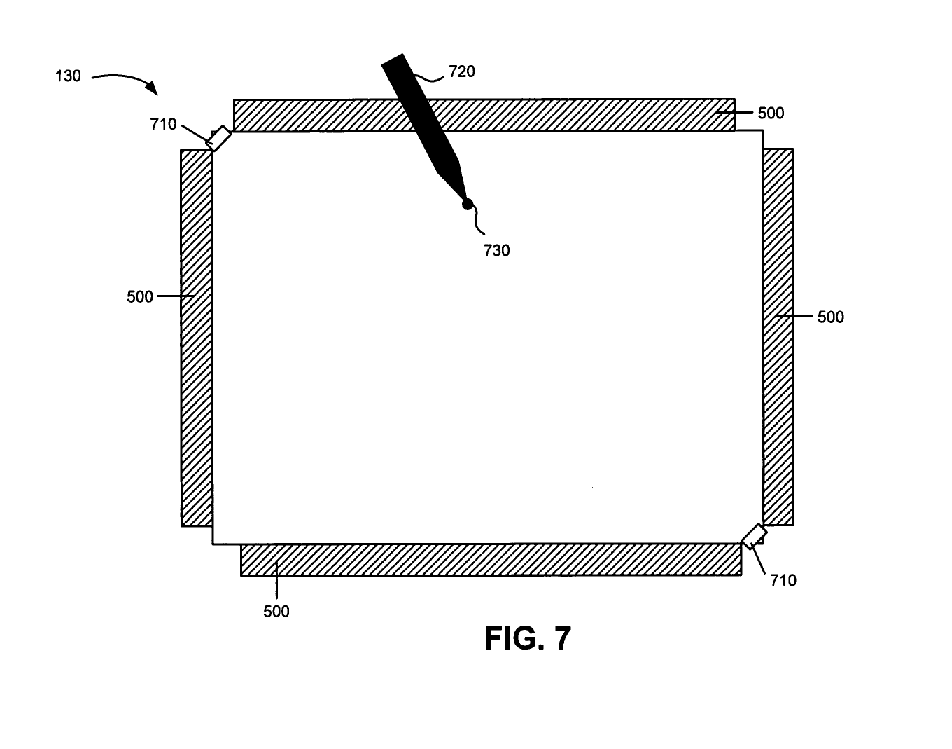

FIG. 6 illustrates an exemplary implementation of display 130 consistent with implementations described herein. Referring to FIG. 6, display 130 may include light source 610, stylus 620, cursor 630, voltage and/or current (V/I) measuring device 640, device/mouse controller 650 and PSD 500. Light source 610 may be an LED, such as a white LED or colored LED, that emits light, as illustrated by the lines in FIG. 6. Stylus 620 may be a conventional stylus or pointer device used to contact the upper surface of display 130. Cursor 630 may be a conventional cursor associated with use of, for example, one of control buttons 134 (FIG. 1) or a mouse. V/I measuring device 640 may include one or more devices used to measure voltage or current at electrodes, such as electrodes 560 and 570 (not shown in FIG. 6 for simplicity) located at opposite ends of PSD 500. Device/mouse controller 650 may include logic to control cursor 630. Device/mouse controller 650 may also include logic to detect a location of input based on information from V/I measuring device 640.

In FIG. 6, assume that a user holding stylus 620 places or touches stylus 620 onto the surface of display 130 at the location illustrated by cursor 630. The terms “touch” and “contact” are used interchangeably herein and should be construed to include any object (stylus, finger, etc.) coming into contact with another object or device, such as the upper surface of display 130. Stylus 620 obstructs or blocks a portion of the light emitted from light source 610 from reaching the surface of PSD 500 at the portion of the surface of PSD 500 labeled 660 in FIG. 6. Based on the absence of light or the shadow cast on PSD 500 at location 660, device/mouse controller 650 may determine the location in the y direction where stylus 620 is touching display 130 (e.g., the distance from the lower end of PSD 500 to location 660). As discussed above, using a single PSD, such as PSD 500, provides a one-dimensional mapping of the location or position of stylus 620 (e.g., in the x or y direction). However, in other implementations, using two or more light sources and two or more PSDs enables mobile terminal 100 to generate a complete x-y mapping of the location of a stylus 620 with respect to display 130.

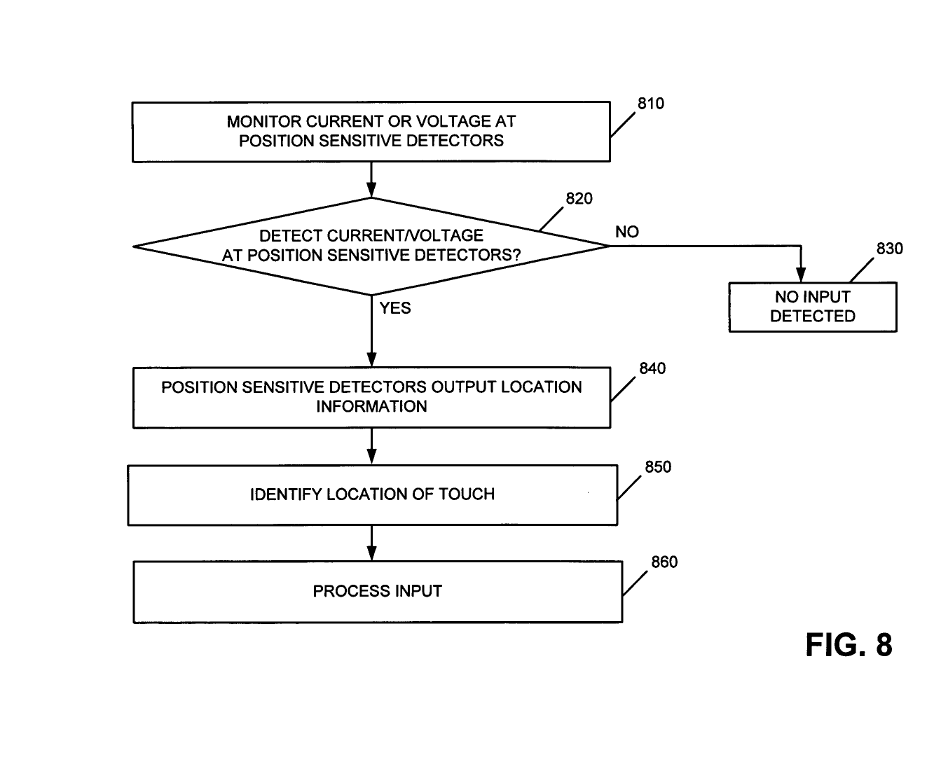

For example, FIG. 7 illustrates a light-based touch screen that maps a touch on a display in two dimensions according to an exemplary implementation. Referring to FIG. 7, display 130 includes two light sources 710 located at opposite corners of display 130. Light sources 710 may be designed to illuminate the entire upper surface of PSDs 500. For example, the light source 710 located in the upper left corner of display 130 may illuminate the entire upper surface of PSDs 500 located on the right side and bottom side of display 130 illustrated in FIG. 7. Light source 710 located in the lower right corner of display 130 may illuminate the entire upper surface of PSDs 500 located on the left side and top side of display 130 illustrated in FIG. 7. Light sources 710 are shown in the upper left and lower right corners of display 130. In other implementations, light sources 710 may be located in the other corners (i.e., lower left and upper right), in all four corners or in other locations. More than four light sources may also be used in some implementations, based on the particular display, and may allow greater resolution with respect to detecting a touch on display 130, as described below. Light sources 710 may be infrared light sources, such as quasi-Lambertian light sources. For example, light sources 710 may be LEDs. Display 130 may include four PSDs 500 located along the sides of display 130. A stylus 720 or a user's finger may contact a portion of display 130, such as at point 730 in FIG. 7, and create a shadow that is detected by one or more of PSDs 500. An x, y position associated with location 730 corresponding to the shadow detected on two more of PSDs 500 may be generated and output by two of PSDs 500. Based on the x, y position output by the two PSDs 500, display control logic 310 may generate X, Y coordinates associated with location 730 on display 130, as described in detail below. Display 130 may then process the input associated with the user's touch/input.

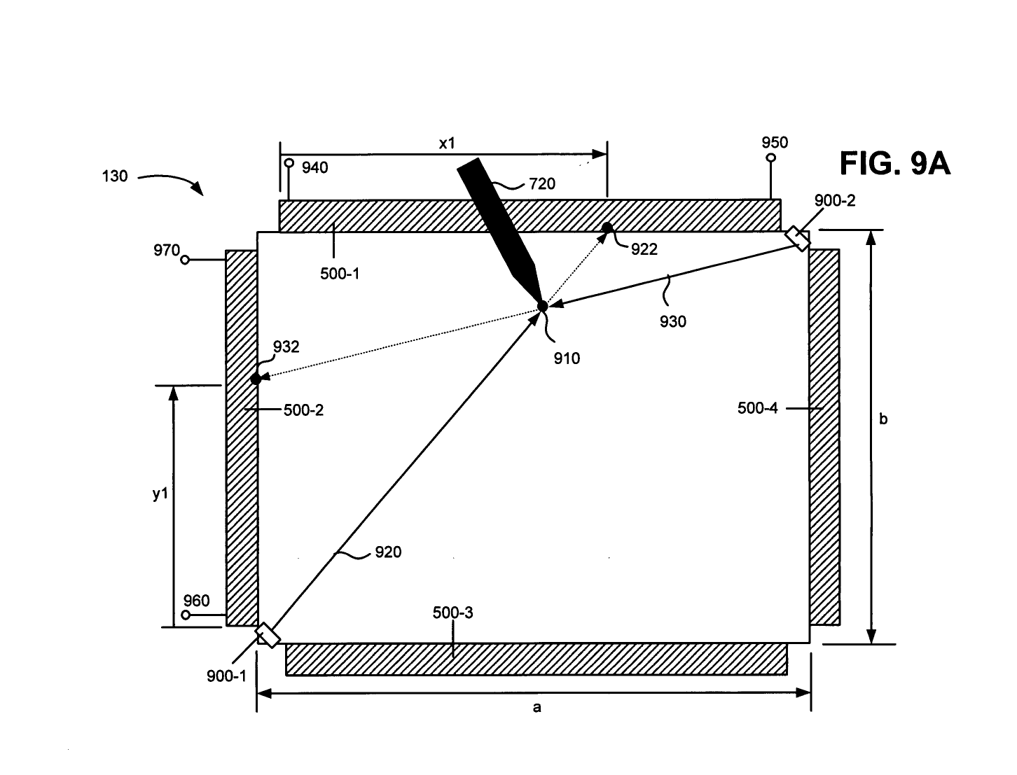

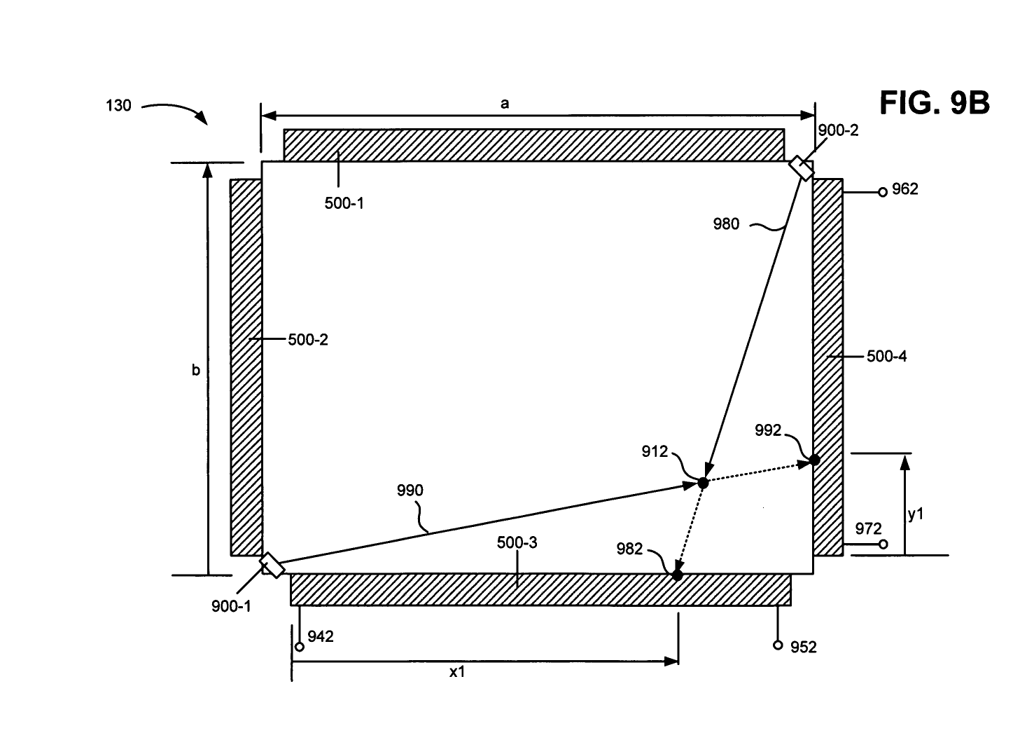

FIG. 8 is a flow diagram illustrating processing by mobile terminal 100 in an exemplary implementation. Processing may begin when mobile terminal 100 powers up. Power supply 260 may provide power to display 130. As discussed above with respect to FIG. 7, display 130 may include a number of light sources (e.g., two or more) and a number of PSDs (e.g., two or more). For example, assume that display 130 is a rectangular display having a length a and width b, as illustrated in FIG. 9A. Further assume that display 130 includes PSDs 500-1, 500-2, 500-3 and 500-4 located along the sides of display 130 and light sources 900-1 and 900-2 located in opposite corners of display 130, as illustrated in FIG. 9A. Light sources 900-1 and 900-2 may be similar to light sources 710 illustrated and discussed above in reference to FIG. 7. For example, light sources 900-1 and 900-2 may be LEDs. Light from light sources 900-1 and 900-2 may be configured to illuminate the entire upper surface of PSDs 500-1 through 500-4. For example, light source 900-1 may be located to illuminate the entire upper surface of PSDs 500-1 and 500-4. Light source 900-2 may be located to illuminate the entire upper surface of PSDs 500-2 and 500-3. It should be noted that only a portion of light emitted from light sources 900-1 and 900-2 (lines 920 and 930, respectively) is schematically shown in FIG. 9 for simplicity.

PSDs 500-1 through 500-4 may continuously monitor the current or voltages generated by the respective PSDs 500 (act 810). Assume that PSDs 500-1 through 500-4 generate no output current (or voltage) (act 820—no). Such a condition may occur when no stylus or finger is placed on the surface of display 130. For example, in this case, the light from light sources 900-1 and 900-2 illuminates the entire upper surface of PSDs 500-1, 500-2, 500-3 and 500-4. As a result, current or voltage measured at electrodes located on opposite ends of each of PSDs 500-1 through 500-4 will be zero and the output from PSDs 500-1 through 500-4 will also be zero. When no current or voltage is output from any of the PSDs 500-1 through 500-4, display control logic 310 determines that no touch-related input on display 130 has occurred or has been detected (act 830). Since touches on display 130 may occur very quickly and very frequently, PSDs 500-1 through 500-4 may continuously monitor the current or voltages to detect any touches on display 130 and output location information to display control logic 310 when a touch occurs.

Assume that a user contacts stylus 720 (or his/her finger) onto the upper surface of display 130, at point 910 illustrated in FIG. 9A. As illustrated, a portion of light from light source 900-1 may be blocked from reaching PSD 500-1. For example, when light illustrated by line 920 in FIG. 9A hits stylus 720, the light associated with line 920 is blocked from reaching PSD 500-1. In addition, stylus 720 may produce a shadow on PSD 500-1 at the location illustrated by the dotted line to point 922 on the surface of PSD 500-1. Similarly, a portion of light from light source 900-2 may be blocked from reaching PSD 500-2 by stylus 720. In addition, stylus 720 may produce a shadow on PSD 500-2 at the location illustrated by the dotted line to point 932 on the surface of PSD 500-2.

In this case, PSDs 500-1 and 500-2 may detect current (or voltage) (act 820—yes). PSDs 500-1 and 500-2 may then determine and output location values x1 and y1 illustrated in FIG. 9A (act 840). These values may correspond to the location of shadows or lack of light at points 922 and 932 on the surfaces of PSDs 500-1 and 500-2, respectively. For example, as described previously, PSD 500-1 may include logic that operates in an inverse mode with respect to a conventional PSD. In the inverse mode, PSD 500-1 may determine the location at which light is not detected or a shadow is detected on the surface of PSD 500-1. In this example, light from light source 500-1 may fall on all portions of the surface of PSD 500-1 other than point 922 since no other obstructions exist in the path of light source 900-1 to PSD 500-1. As a result of the detected absence of light at point 922, PSD 500-1 may generate voltage or current values. PSD 500-1 may use this current or voltage to identify and output location information associated with a touch on the surface of display 130 to display control logic 310 (acts 820—yes, and 840).

For example, in one implementation, to calculate the location associated with point 922, PSD 500-1 may subtract the current measured at electrode 940 from the current measured at electrode 950 and divide this difference by the sum of currents measured at electrodes 940 and 950 (i.e.,

$$\frac{{I}_{950} - {I}_{940}}{{I}_{950} + {I}_{940}} ,$$

where I₉₄₀ and I₉₅₀ are the currents measured at electrodes 940 and 950, respectively). In some implementations, this quotient may then be multiplied by a scaling factor associated with the length of PSD 500-1, resulting in the value x1. PSD 500-2 may calculate the location associated with point 932 in a similar manner. That is, PSD 500-2 may subtract the current measured at electrode 960 from the current measured at electrode 970 and divide this difference by the sum of currents measured at electrodes 960 and 970 (i.e.,

$$\frac{{I}_{970} - {I}_{960}}{{I}_{970} + {I}_{960}} ,$$

where I₉₆₀ and I₉₇₀ are the currents measured at electrodes 960 and 970, respectively). Similar to PSD 500-1, in some implementations, PSD 500-2 may multiply the quotient by a scaling factor associated with the length of PSD 500-2, resulting in the value y1.

PSD 500-1 and 500-2, respectively, may output the values x1 and y1 (act 840). Values x1 and y1 may provide location information associated with where shadows fell incident on PSDs 500-1 and 500-2. Display control logic 310 (FIG. 3) may receive the values x1 and y1 and determine the location of the touch on display 130 corresponding to the values x1 and y1 (act 850). For example, based on the geometry of display 130 illustrated in FIG. 9A, display control logic 310 may calculate the X, Y coordinates of the touch point (i.e., point 910) based on equation 1 below.

$$X = \frac{y 1}{\frac{b}{x 1} + \frac{y 1 - b}{a}} , Y = \frac{y 1}{1 + \frac{x 1}{b} \frac{( y 1 - b )}{a}} \qquad Equation ( 1 )$$

Display control logic 310 may then use the coordinates X,Y to determine that the user intended to provide input via a particular visual or display element on display 130. For example, the X, Y coordinates of point 910 may correspond to a number on keypad 136, one of control buttons 134, a visual icon on upper display 132, etc. Display control logic 310 may then process this touch input on display 130 (act 860). For example, assume that the detected touch corresponded to an icon associated with playing a song on mobile terminal 100. In this case, display control logic 310 may signal processing logic 220 or another device to play the desired song.

FIG. 9A illustrates an example associated with a touch occurring on an upper portion of display 130. For example, if a diagonal connected light sources 900-1 and 900-2, point 910 is included in the upper portion of display 130. When an input point is located on the lower half of display 130, display control logic 310 may use another equation to calculate the X,Y coordinates.

As an example, suppose that the user of mobile terminal 100 touches display (with his/her finger or using a stylus) at point 912 in FIG. 9B. In this case, light from light source 900-1 identified by line 990 is blocked from reaching PSD 500-4 at point 992. Similarly, light from light source 900-2 is blocked from reaching PSD 500-3 at point 982. In this case, PSD 500-3 and 500-4, respectively, may generate and output the values x1 and y1 illustrated in FIG. 9B corresponding to the locations of points 982 and 992 (in a similar manner to that described above with respect to PSDs 500-1 and 500-2 in FIG. 9A). That is, PSD 500-3 will measure the current (or voltages) at electrodes 952 and 942, perform a similar calculation to that described above with respect to PSD 500-1 in FIG. 9A, and generate the value x1 illustrated in FIG. 9B. PSD 500-4 will measure the current (or voltage) at electrodes 962 and 972, perform a similar calculation to that described above with respect to PSD 500-2 in FIG. 9A, and output the value y1 illustrated in FIG. 9B.

Display control logic 310 may receive the values x1 and y1 and determine the X,Y coordinates associated with point 912 on display 130 using equation 2 below.

$$X = \frac{x 1 \cdot b}{y 1 ( \frac{x 1}{a} - 1 ) + b} , Y = \frac{x 1 \cdot b}{x 1 - a + \frac{ab}{y 1}} \qquad Equation 2$$

Therefore, display control logic 310 may use equation 1 or 2 based on the particular location of a detected touch/input on display 130. That is, if the touch is located in the upper half of display 130 (where display is divided on a diagonal connecting PSDs 900-1 and 900-2), equation 1 may be used. If the touch is located in the lower half of display 130, equation 2 may be used.

In one implementation, display control logic 310 may determine which calculation to perform (i.e., use equation 1 or 2) based on which PSDs 500-1 through 500-4 output location information. For example, if a touch occurs in the upper half of display 130, as illustrated in FIG. 9A, PSDs 500-1 and 500-2 will output values x1 and y1, while PSDs 500-3 and 500-4 will not generate any values since no output current (or voltage) will be detected by these PSDs because their entire upper surfaces will be illuminated by light sources 900-1 and 900-2. Similarly, if a touch occurs in the lower half of display 130, as illustrated in FIG. 9B, PSDs 500-3 and 500-4 will output values x1 and y1, while PSDs 500-2 and 500-2 will not generate any values since no output current (or voltage) will be detected by these PSDs because their entire upper surfaces will be illuminated by light sources 900-1 and 900-2. Therefore, display control logic 310 may apply the appropriate calculation based on which particular PSDs provided location information.

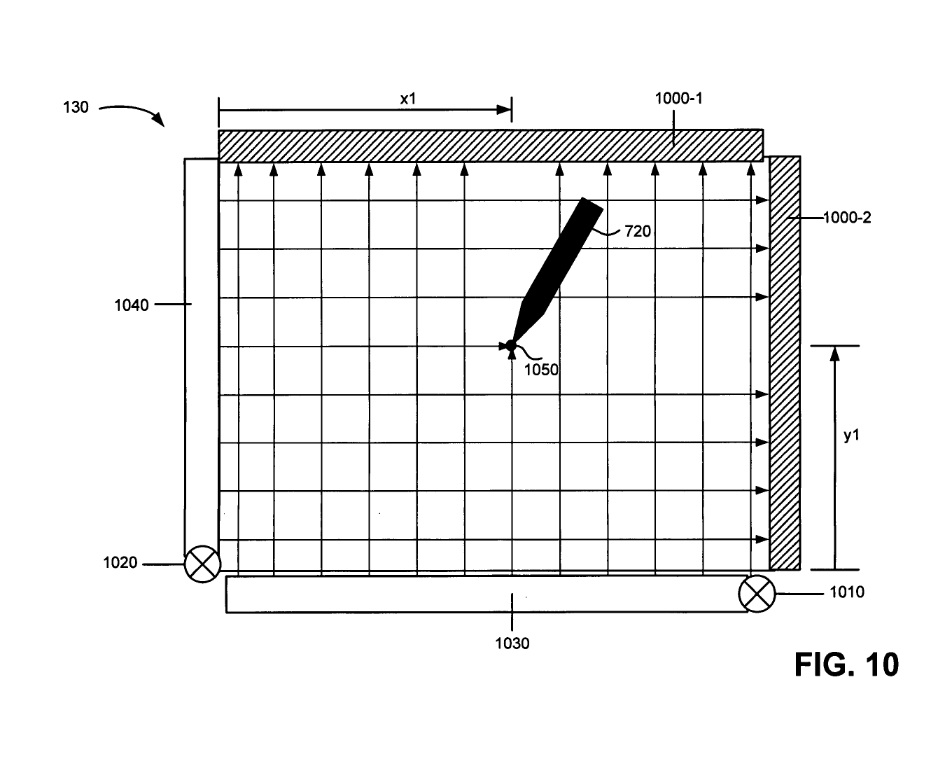

In another implementation, display 130 may include two PSDs and two light sources. For example, referring to FIG. 10, display 130 may include PSDs 1000-1, 1000-2, light sources 1010 and 1020, light guides 1030 and 1040. PSDs 1000-1 and 1000-2 may be similar to PSDs 500 described above with respect to FIGS. 9A and 9B. Light sources 1010 and 1020 may each include a conventional light source, such as an LED, a fluorescent light source, an incandescent light source, etc. Only two light sources 1010 and 1020 are shown for simplicity. It should be understood that additional light sources may be provided and each of light source 1010 and 1020 may include a number of individual light sources, such as a number of LEDs. Light guides 1030 and 1040 may be conventional light guides that direct light from a light source in an even manner (i.e., substantially planar). For example, as illustrated by the lines from light guide 1030 in FIG. 10, light guide 1030 directs light from light source 1010 in an even, distributed manner across display 130 to PSD 1000-1. Similarly, light guide 1040 may direct light in an even, distributed manner across display 130 to PSD 1000-2, as indicated by the lines from light guide 1040 in FIG. 10.

In this implementation, suppose that a user contacts stylus 720 with the upper surface of display 130 at point 1050 in FIG. 10. As illustrated, a portion of light directed from light guide 1030 is blocked from reaching PSD 1000-1. Similarly, a portion of light from light guide 1040 is prevented from reaching PSD 1000-2. PSDs 1000-1 and 1000-2 may then generate and output values x1 and y1, respectively, in a similar manner to that described above with respect to PSDs 500 in FIGS. 9A and 9B. In this case, the values x1 and y1 may correspond to the X,Y coordinates of touch point 1050 on display 130. Therefore, in this implementation, no further scaling or calculating associated with the output of PSDs 1000-1 and 1000-2 may be needed to identify the input point 1050 on display 130. That is, display control logic 310 may receive the values x1, y1 from PSDs 1000-1 and 1000-2, identify an input element displayed on display 130 corresponding to these coordinates, and process the identified input element. For example, assume that the detected touch corresponded to a location in an area where the number 8 was displayed on keypad 136. In this case, display control logic 310 may display the number 8 in upper display 132.

PSDs 1000 (or 500) and display control logic 310 may continue to operate to detect and process the user's inputs via touch screen display 130. In this manner, display 130 may act as an optical touch screen without providing additional elements/components on the surface of display 130. This may help prevent loss of front-of-screen performance and also allows display 130 to remain very thin.

As discussed above, display control logic 310 may receive information from PSDs and determine whether a touch/input on display 130 has occurred. In some implementations, PSDs and/or display control logic 310 may be used in conjunction with other mechanisms to avoid false touch indications. For example, PSDs 500 or 1000 may determine whether a detected current (or voltage) associated with a potential touch meets a predetermined threshold. If the current (or voltage) is very low, this may indicate that a touch has not occurred. In other instances, if the current (or voltage) exceeds a predetermined upper threshold, this may indicate an error with respect to display 130.

In still other instances, a displacement or vibration sensor may be included on the surface of display 130 to ensure that values output by PSDs 500 and 1000 are associated with actual touches on the surface of display 130 and are not associated with a hand or other object passing over the top of display 130 that may cause a shadow on a portion of the PSDs 500 or 1000. For example, prior to a finger or stylus (or some other object) actually contacting display 130, the user may pass his/her hand or finger, a stylus or some other object over display 130. Such movement of an object over display 130 may cause a shadow on the surface of display 130. In this case, using a displacement or vibration sensor that senses an object actually touched some portion of display 130 may help avoid false touch indications on display 130. That is, a displacement sensor or vibration sensor may sense small displacements or movement of the upper portion of display 130. When this displacement/movement is detected, display control logic 310 may process the output of the PSDs since the output will most likely correspond to a user-intended touch/input on display 130.

In some implementations, display control logic 310 may also be used to detect multiple touches at different locations on display 130 that occur simultaneously or substantially simultaneously. For example, if a user touches two of his/her fingers at the same time at different locations on display 130, light may be blocked at multiple locations on a PSD. Display control logic 310 may then determine the locations or areas of the multiple touches on display 130 based on the output of the PSDs 500. For example, assume that a touch occurred in the upper half of display 130 simultaneously, or substantially simultaneously, with a touch in the lower half of display 130. In this case, PSDs 500-1 and 500-2 may output location values to display control logic 310 representing the touch in the upper half of display 130 and PSDs 500-3 and 500-4 may output location values to display control logic 310 representing the touch in the lower half of display 130. In this manner, a user may provide any number of touches simultaneously or substantially simultaneously and display control logic 310 will be able to detect and process the multiple touches/inputs.

As also discussed above, PSDs 500 or 1000 may measure output current (or voltage) values and calculate location information based on the measured current (or voltage). In other instances, PSD 500 or 1000 or display control logic 310 may compare the output current (or voltage) values to pre-stored current (or voltage values) stored in mobile terminal 100. These pre-stored values may be experimentally determined prior to use of mobile terminal 100 and may include corresponding coordinate information associated with the location of the touch. For example, memory 230 (FIG. 2) may store current (or voltage) values associated with a grid of display 130, where each value has a corresponding X, Y coordinate location on display 130. These values may correspond to expected current (or voltage) readings for various PSDs based on touches located at the corresponding X, Y coordinates. Display control logic 310 and/or PSD 500 or 1000 may compare the generated current (or voltage) to the stored values and identify the corresponding X, Y coordinates. These X, Y coordinates would then correspond to the location of the touch.

### CONCLUSION

Implementations described herein provide a touch screen display using position sensitive detectors. Advantageously, this may enable the display to provide good front-of-screen performance and remain very thin. In addition, using PSDs, as opposed to small discrete arrays of multi-element sensors, such as charge coupled device (CCD) sensors, reduces the total number of input/output (I/O) elements, and also reduces the number of interconnects. This may help reduce the cost of the display and also reduce power requirements associated with the touch screen display.

Further, in conventional IR touch screens, the resolution associated with the detected touch is determined based on the number of LED and detectors per unit length. In accordance with aspects described herein, resolution associated with detecting location of shadows or lack of light on the surface of PSDs may be on the sub-micron level. This may enable touch screen display 130 to have sub-pixel resolution with respect to detecting inputs, based on the light source. As a result, touches may be accurately detected for even small displays.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, aspects of the invention have been mainly described with respect to a rectangular display having two light sources and two or four PSDs. In other implementations, the number of light sources and/or PSDs may be increased. Increasing the number of the light sources and/or increasing the number of PSDs may allow for even greater resolution with respect to detecting touches on a display. In such instances, positioning of the light sources and/or PSDs may be selected to optimize the resolution with respect to detected touches. Still further, aspects of the invention may be employed in 1-dimensional displays, such as the display illustrated in FIG. 6, where only a single location value may be needed to identify the input/display element.

In addition, aspects have been mainly described with respect to using LEDs, incandescent or fluorescent light sources that distribute light in all directions. In other instances, light sources that output light in a point-to-point manner, such as a laser or laser-like light source, may be used. In such instances, the number of light sources may correspond to the number of input elements on display 130. For example, if touch screen display 130 includes a 10×10 grid of display elements that may be selected via touching one of the display elements, ten laser light sources may be located on one side of display 130 and ten laser light sources may be located on an adjacent side of display. For example, ten point-to-point light sources may be used instead of light source 1010 and light guide 1030 illustrated in FIG. 10 and ten point-to-point light sources may be used instead of light source 1020 and light guide 1040 illustrated in FIG. 10.

Still further, aspects of the invention have been mainly described in the context of a mobile terminal. As discussed above, the invention may be used with any type of device that includes a display. It should also be understood that particular formulas or equations discussed above are exemplary only and other formulas or equations may be used in alternative implementations to generate the desired information.

Further, while a series of acts have been described with respect to FIG. 8, the order of the acts may be varied in other implementations consistent with the invention. Moreover, non-dependent acts may be performed in parallel.

It will also be apparent to one of ordinary skill in the art that aspects described herein may be implemented in methods and/or computer program products. Accordingly, aspects of the invention may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain aspects described herein may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A device, comprising:
a display comprising:
a first position sensitive detector, the first position detector configured to generate a first value corresponding to a location associated with a shadow or absence of light on an upper surface of the first position sensitive detector, and
a second position sensitive detector, the second position sensitive detector configured to generate a second value corresponding to a location associated with a shadow or absence of light on an upper surface of the second position sensitive detector; and
logic configured to:
receive the first and second values,
determine that a contact occurred on the display, and
determine a location of the contact based on the first and second values.

2. The device of claim 1, further comprising:
a first light source configured to illuminate all of the upper surface of the first position sensitive detector when no object is contacting the display; and
a second light source configured to illuminate all of the upper surface of the second position sensitive detector when no object is contacting the display.

3. The device of claim 2, wherein the first position sensitive detector is configured to generate the first value in response to a user's finger or stylus contacting the display, and
the second position sensitive detector is configured to generate the second value in response to the user's finger or stylus contacting the display.

4. The device of claim 2, wherein the first and second light sources each comprise at least one light emitting diode.

5. The device of claim 2, further comprising:
a first light guide located adjacent the first light source and on an opposite side of the display than the first position sensitive detector, the first light guide configured to direct light from the first light source to the first position sensitive director; and
a second light guide located adjacent the second light source and on an opposite side of the display than the second position sensitive detector, the second light guide configured to direct light from the second light source to the second position sensitive detector.

6. The device of claim 1, wherein the logic is further configured to:
determine an input element on the display corresponding to the location of the contact, and
process the input element.

7. The device of claim 1, wherein when determining the location of the contact, the logic is configured to:
determine coordinates associated with the contact, the coordinates being based on the first and second values and a length and width of the display.

8. The device of claim 1, further comprising:
a third position sensitive detector; and
a fourth position sensitive detector, wherein two of the first, second, third and fourth position sensitive detectors are configured to output location information in response to a user's finger or stylus contacting an upper surface of the display.

9. The device of claim 8, wherein the logic is further configured to:
determine which two of the four position sensitive detectors output location information,
perform a first calculation to identify a location on the display when the first and second position sensitive detectors output location information, and
perform a second calculation to identify a location on the display when the third and fourth position sensitive detectors output location information.

10. The device of claim 8, wherein the logic is further configured to:
detect multiple contacts on the display that occur simultaneously or substantially simultaneously based on information received from the first, second, third and fourth position sensitive detectors.

11. The device of claim 1, wherein the device comprises a mobile telephone.

12. In a device comprising a display, a method comprising:
generating, by a first position sensitive detector, a first value corresponding to a location associated with a shadow or absence of light on an upper surface of the first position sensitive detector;
determining that a contact occurred on the display based on the first value; and
determining a location of the contact based on the first value.

13. The method of claim 12, further comprising:
identifying a display element associated with the location of the contact; and
processing an input associated with the display element.

14. The method of claim 12, further comprising:
generating, by a second position sensitive detector, a second value corresponding to a location associated with a shadow or absence of light on an upper surface of the second position sensitive detector, wherein determining the location of the contact further comprises:
determining the location of the contact based on the second value.

15. The method of claim 14, wherein the generating a first value comprises:
generating a current or voltage by the first position sensitive detector, and
converting the current or voltage into a linear position on the first position sensitive detector, the linear position corresponding to the location associated with the shadow or absence of light on the upper surface of the first position sensitive detector, and wherein generating a second value comprises:
generating a current or voltage by the second position sensitive detector, and
converting the current or voltage into a linear position on the second position sensitive detector, the linear position corresponding to the location associated with the shadow or absence of light on the upper surface of the second position sensitive detector.

16. The method of claim 14, further comprising:
monitoring output of the first and second position sensitive detectors; and
determining that the contact occurred when the current or voltage generated by at least one of the first and second position sensitive detectors is not zero.

17. The method of claim 14, wherein the device comprises the first position sensitive detector, the second position sensitive detector, a third position sensitive detector and a fourth position sensitive detector, the method further comprising:
generating location information, by two of the first, second, third and fourth position sensitive detectors, in response to a user's finger or stylus contacting an upper surface of the display.

18. The method of claim 14, further comprising:
detecting multiple contacts on the display that occur simultaneously or substantially simultaneously based on information received from the first and second position sensitive detectors.

19. A device, comprising:
display means for generating first and second values corresponding to a location associated with a shadow or absence of light on a portion of the display means; and
input detection means for determining that a touch occurred on the touch screen based on the first and second values and determining a location of the touch based on the first and second values.

20. The device of claim 19, wherein the display means comprises a plurality of position sensitive detectors, and wherein the input detection means is configured to:
receive location information from two of the position sensitive detectors in response to a user's finger or stylus contacting an upper surface of the touch screen.

21. The device of claim 19, further comprising:
input processing means for identifying a display element on the touch screen associated with the location of the touch and processing an input associated with the display element.
